(19) United States
(12) Patent Application Publication
(10) Pub. No.: US 2016/0143454 A1
(43) Pub. Date: May 26, 2016

(54) DISPLAY HANGER

(71) Applicant: Fantasia Accessories, Ltd., New York, NY (US)

(72) Inventor: Michael Brett, New City, NY (US)

(21) Appl. No.: 14/548,625

(22) Filed: Nov. 20, 2014

(51) Int. Cl. A47F 5/00; G09F 3/02; A47F 7/00; F16M 13/02

(52) U.S. Cl. CPC A47F 5/0006; F16M 13/02; G09F 3/02; A47F 7/0021; G09F 2003/027

(57) ABSTRACT

An item display and support device for elongated items, such as umbrellas, to be displayed in a hanging origination comprises a central panel adapted for the display of information associated with the item to be supported; a first attachment member connected to the central panel for supporting the device in a hanging orientation from a display fixture, and a second attachment member comprising an item retainer element and a pivotable connector between the retainer element and the central panel to allow the item to be suspended in a generally vertical orientation from the device. The item retainer element may being the form of a ring having flexible flanges extending inwardly about a central aperture. An end of an item to be hung is inserted through the retainer element central aperture, the flanges flexing to receive the item and gripping the item when the insertion force is released. The item hands downwardly from the retainer element which pivots into a generally horizontal orientation, orienting the inserted item vertically.

The present invention relates to a new and improved device for the display of products, such as umbrellas, and which is particularly well suited for the display of such products in a retail store environment.

### BACKGROUND OF THE INVENTION

The shapes of objects often make them difficult to be displayed in a retail sales environment in a convenient and attractive manner. Umbrellas are an example of a type of object whose elongated shapes can make it hard to present them in a well-laid out display. Typically, umbrellas may be simply stacked or piled on a shelf or in a cubby, but such displays are unattractive. When piled on a shelf, the umbrellas are prone to disarray and dropping, particularly when a customer chooses an umbrella located within the body of the pile. When displayed in a cubby the customer typically sees only the exposed ends of the array, and thus has a limited view of the overall length and color of the product. A hangtag with UPC and pricing information is typically fastened to the umbrella by a plastic cord.

Some umbrellas are provided with a hand loop at the handle end. The loop allows the umbrella to be hung from a rack, a more efficient and favored display orientation, but still requires a hangtag to be separately affixed to the product. The umbrella typically hangs at an awkward angle from the hand loop, providing an unattractive display.

Accordingly it is a purpose of the present invention to provide a device to allow umbrellas and similar elongated items to be displayed in a hanging orientation in a manner that provides an attractive overall display.

A further purpose of the present invention is to provide a device that incorporates an area in which item information can be located, avoiding the need for a separate hangtag for the item.

A still further purpose of the present invention is to provide a display device with the forgoing features that is of efficient and economical manufacture, and which can be affixed to the item to be displayed in a simple manner.

### BRIEF DESCRIPTION OF THE INVENTION

In accordance with the foregoing and other objects and purposes, a display hanger device of the present invention is a generally planar member having an attachment member at a first end allowing the hanger and attached item to be supported in a hanging orientation on display fixture or rail. The attachment member may be a hook. The hanger further has a central area to accommodate sales and inventory information, such as a slicker or label bearing the item name and price and UPC information. Alternatively, such information may be printed or embossed directly upon the central area. Extending downward from the central area is a second attachment member adapted to engage or retain the umbrella or other displayed item, preferably at an end thereof. The second attachment member may include a gripping element, comprising an apertured element through which a distal end of the item to be displayed is inserted, the aperture being dimensioned and adapted to securely grip the item upon insertion and allow it to hang suspended form the hanger when the hanger is placed on the display rack or rail. The gripping element may be joined to the central area by a neck element flexibly joined to at least one of the aperture element and the central area, allowing the aperture element to pivot into a generally horizontal orientation when the item is held by the hanger and the hanger is in place on the display fixture or rail, whereby the umbrella or other item bangs directly below the hanger.

### BRIEF DESCRIPTION OF THE DRAWINGS

A full understanding of the invention will be achieved upon consideration of the following description of an illustrative embodiment of the invention when considered in association with the annexed drawing, wherein:

FIG. 1 is a front elevation view of the invention;

FIG. 2 is a detail view of a portion of a gripping element of the invention;

FIG. 3 illustrates an umbrella with which the invention may be used, oriented for insertion into the hanger;

FIG. 4 depicts the umbrella supported by the hanger; and

FIG. 5 depicts an alternative construction for the gripping element.

### DETAILED DESCRIPTION OF THE INVENTION

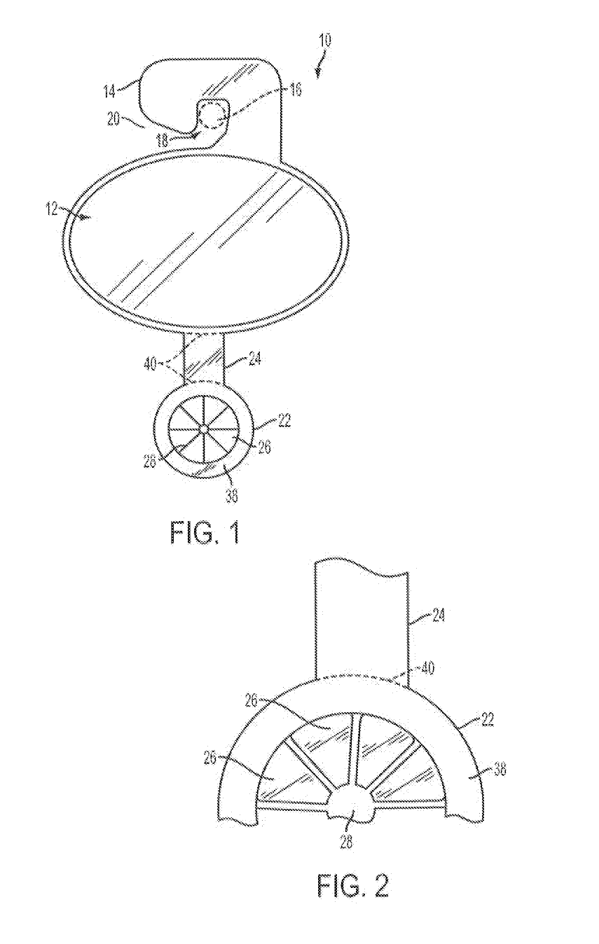

As shown in FIG. 1, hanger 10, which may be formed of an appropriate sheet plastic, die cut or molded to shape, comprises central panel section 12 dimensioned and sized to accept information, such as the product name, descriptive text, and price data for the product to which the hanger is to be affixed. The information may, for example, be printed on a paper label, which is adhesively mounted to the panel. Either or both sides of the panel may carry information. To allow the affixed item to be displayed upon a display fixture, such as a rack or rail, a first attachment member, which may be in the form of hook 14, extends upwardly from the central panel, allowing display fixture rail 16, shown in phantom, to be captured within the hook aperture 18, access to the aperture being accommodated by entranceway 20 between the distal portion of the hook and the upper edge of the central panel. The hanger and the affixed product thus hang from the fixture rail. As a primary use of the hanger is in retail sales environments, the attachment member is preferably configured and dimensioned to facilitate engagement mounting to the display fixture and removal therefrom in conjunction with the supported product in connection with a purchase decision by a customer or for inventory rotation or changes by store personnel.

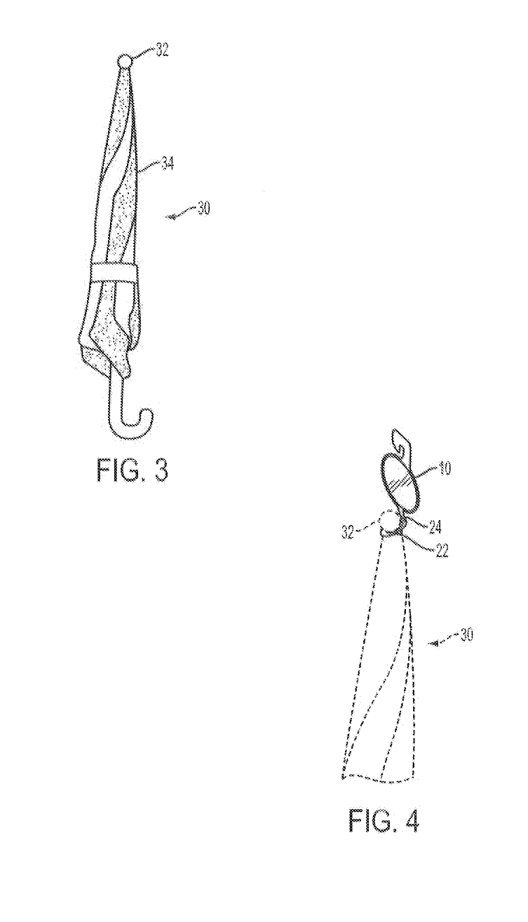

A second attachment member comprises item retainer or gripping element 22, located below the central panel and connected to the lower edge of the panel by a connector 24, which may comprise one or more individual necks or arms between the central panel and the retainer. The retainer 22 is adapted to hold the item to be displayed, and as may be further seen in FIG. 2, may preferably be formed as a ring with a series of inwardly directed flap or flange segments 26 extending inwardly from peripheral band 38 about central aperture 28. When a portion of the item to be supported is inserted through the ring, the flap segments flex to allow passage of the portion, while engaging the portion to hold it in the inserted position. The flaps may lie in the same plane as the peripheral band or may be canted to facilitate insertion or removal of the item to be supported from the ring. The flap segments also may be of the same or different thickness as the peripheral band to provide appropriate rigidity and flexure for accommodating and supporting the item. The connector 24 is joined to the central panel and gripping element by regions 40 which may be of a lessened thickness than the adjacent portions of the connector and the retainer 22 to localize flexure of the connector at those locations, providing a pair of integral hinge elements between the connector on the one hand and the central panel and ring on the other.

FIG. 3 depicts an umbrella 30 which is illustrative of items that may be supported by the hanger. As may be seen, the umbrella may include a ball or protrusion 32 at the top of the umbrella canopy 34. The diameter of the ball, which may be on the order of 18 mm, is greater than the diameter of the top of the canopy 34. The diameter of the retainer 22 and thus the length of the flap segments 26 are is chosen to allow the umbrella ball 32 to be inserted through the interior of the retainer, the flaps flexing to allow passage of the ball, then returning to a less-flexed position, engaging the top of the umbrella canopy 34, while the larger diameter ball 32 rests upon the top surfaces of the flaps when in the hanging position, providing an increased diameter ledge against the flaps and offering further resistance to the umbrella falling or dropping out of the retainer. When it is desired to remove the umbrella from the retainer, however, the user can easily exert a separating force to allow the umbrella top and ball to pass back through the retainer and be separated from the hanger. It is to be appreciated that with appropriate choice of retainer diameter, flange size and diameter of the central aperture 28, the hanger can be used with a variety of elongated objects. While an object to be hung may have a neck formed below a distal protuberance, such as the umbrella ball 32, the object need not have such a construction to be supported by the hanger. With a properly sized and dimensioned retainer sufficient frictional contact between the segments and the engaged item can be provided to maintain the item in the hanging position.

FIG. 4 details the umbrella 30 hanging from the hanger 10. The hanger's connector 24, joined to the hanger's other elements by the hinge lines 40, is responsive to the weight of the hanging item, permitting the hanger elements to pivot with respect to each other such that the hanging umbrella 30 assumes a substantially vertical position below the hanger 10. The incorporation of more than one flexible connector arms 24, and the choice of their positioning with respect to the periphery of the retainer 22, may affect the ultimate orientation assumed by the hanging item. In general, an orientation to the true vertical is typically desired. Depending on the location of the arm and the flexure allowed by the provided hinge lines, hinge lines at both ends of the connector may not be necessary or desired.

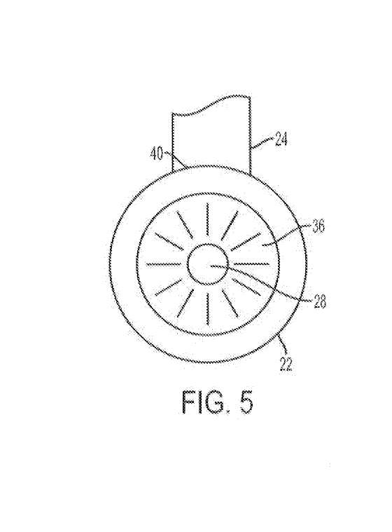

A variety of retainer 22 constructions may be utilized. For example, as depicted in FIG. 5, instead of a flap construction, a construction in which a diaphragm 36 of thin rubber or elastic with a central aperture 28 may be employed. The diaphragm distorts and stretches to allow the item to pass through the diaphragm aperture under the insertion force applied by the user, but grips the item and supports it in the desired suspended orientation.

I claim:

1. An item display and support device, comprising a central panel adapted for the display of information associated with an item to be supported; a first attachment member connected to the central panel for supporting the device in a hanging orientation from a display fixture; and a second attachment member comprising an item retainer element and a pivotable connector between the retainer element and the central panel to suspend the item in a generally vertical orientation from the device.

2. The device of claim 1, wherein the first attachment member is a hook.

3. The device of claim 1 wherein the retainer comprises a plurality of flexible flaps surrounding an aperture.

4. The device of claim 1 wherein the retainer comprises a flexible diaphragm with a central aperture.

5. The device of claim 1 wherein the central panel and first and second attachment members form a unitary plastic construction.

6. The device of claim 1 wherein the pivotable connector comprises at least one arm between the retainer and central panel.

7. The device of claim 6 wherein the retainer is pivotable from an orientation coplanar with the central panel to an orientation generally perpendicular thereto when the item is suspended from the device.

8. The device of claim 6 in which the at least one arm is provided with at least one region facilitating the pivoting of the retainer.

9. The device of claim 8 wherein the at least one facilitating region is in the form of a hinge.

10. The device of claim 9 wherein the hinge is an integral hinge.
